(19) United States
(12) Patent Application Publication
(10) Pub. No.: US 2020/0001732 A1
(43) Pub. Date: Jan. 2, 2020

(54) TRANSPORT TRAILER WITH ON-BOARD CHARGING STATION

(71) Applicant: Delta Systems, Inc., Streetsboro, OH (US)

(72) Inventors: Tanios Elias Nohra, Broadview Heights, OH (US); Tony Aboumrad, North Royalton, OH (US); Michelle R. Specht, Mantua, OH (US); Andy Dobrovic, Hinckley, OH (US)

(21) Appl. No.: 16/455,014

(22) Filed: Jun. 27, 2019

Related U.S. Application Data
(60) Provisional application No. 62/690,462, filed on Jun. 27, 2018.

(51) Int. Cl. B60L 53/30; B60L 53/60

(52) U.S. Cl. CPC B60L 53/30; B60L 53/60; B60Y 2200/221; B60Y 2200/145; B60Y 2200/252; B60Y 2200/225; B60Y 2200/223

(57) ABSTRACT

A transport trailer, method of construction of the trailer, and method of operation of the trailer that supplies electrical power to power equipment during transport, the transport trailer includes a power coupling for receiving power from a vehicle towing the transport trailer and conduit for transmitting the power from the vehicle to a power charging arrangement, the power charging arrangement comprising a power transmitting pad compatible with a power capture resonator used to charge an on-board battery of power equipment.

### CROSS REFERENCES TO RELATED APPLICATIONS

The following application claims priority under 35 U.S.C. § 119(e) to co-pending U.S. Provisional Patent Application Ser. No. 62/690,462 filed Jun. 27, 2018 entitled TRANSPORT TRAILER WITH ON-BOARD CHARGING STATION. The above-identified application is incorporated herein by reference in its entirety for all purposes.

### TECHNICAL FIELD

The present disclosure relates generally to a transport trailer with an on-board charging station, and more specifically, to a trailer for transporting power equipment such as lawn mowers, tractors, and the like, the trailer having a single or plurality of charging stations for providing power requirements to the power equipment.

### BACKGROUND

Lawn care tasks are commonly performed using various conventional gas powered machines such as lawn mowers that are driven by a gas engine that through a system of pulleys and belts rotate cutting blades for cutting grass. Lawn mowers themselves may have many different configurations, such as riding mowers, walk-behind mowers, and lawn tractors. Lawn tractors by comparison to riding mowers are typically larger and have been referred to as compact tractors offering accessories such as tillers, a three-point hitch, and front-end loaders.

Most of today's lawn mowers are powered by gas-fueled combustion engines (hereinafter “engines”) as opposed to electric motors (hereinafter “motors” or “electric motors”). However, engines have many shortcomings relative to electric motors. For example, engines require the purchase and storage of gasoline, diesel fuel, or other types of highly combustible fluid, creating a potential hazard. Moreover, the fuel for engines requires frequent trips to service stations for most residential mowers. Engines also require continuous maintenance such as a regular changing of engine oil and spark plugs to provide a long lasting life and proper operation. And unlike electric motors, engines are also known to be relatively loud and undesirably expel hydrocarbons as a result of the internal combustion of the fuel.

Because of the shortcomings described above for internal combustions engines, future trends will likely result in a rise in production of electrically powered lawn mowers and power equipment. For the purpose of this disclosure, it should be appreciated that “power equipment” can be electrically powered lawn mowers or any equipment or machinery having electrically powered motors, such as all-terrain vehicles (ATVs), walk-behind mowers, snow blowers, snow mobiles, jet skis, and the like.

### SUMMARY

One example embodiment of the present disclosure includes a transport trailer for supplying electrical power to power equipment during transport, the transport trailer comprising a power coupling for receiving power from a vehicle towing the transport trailer, and a conduit for transmitting the power from the power coupling to a wireless power charging arrangement, the wireless power charging arrangement comprising a power transmitting pad compatible with a power capture resonator used to charge an on-board battery of power equipment.

Another example embodiment of the present disclosure includes a method of supplying electrical power to power equipment during transport, the method comprising the steps of providing a power coupling for receiving power from a vehicle towing a transport trailer, configuring dimensions of a wireless power charging arrangement comprising a power transmitting pad and a power capture resonator, the power transmitting pad compatible with the power capture resonator, to comport to an indicated specifications of an item of power equipment, and providing the wireless power charging arrangement on a floor panel of the transport trailer, the wireless power charging arrangement in electrical communication with to the power coupling

Another example embodiment of the present disclosure includes a transport trailer for supplying electrical power to power equipment during transport, the transport trailer comprising a floor panel coupled to a set of wheels by an axle; a hitch coupled to the floor panel, the hitch for coupling the transport trailer to a vehicle, a power coupling for receiving power from the vehicle towing the transport trailer, conduit for transmitting the power from the power coupling to a wireless power charging arrangement. The wireless power charging arrangement comprising a power transmitting pad, wherein the power transmitting pad is integrated into a rubber mat disposed on the floor panel. A power capture resonator compatible and in electrical communication with the power transmitting pad, the power capture resonator vertically spaced from the power transmitting pad, wherein the power equipment is mounted upon the power capture resonator to charge an on-board battery of power equipment during the transport of the power equipment while residing on the transport trailer.

### BRIEF DESCRIPTION OF THE DRAWINGS

The foregoing and other features and advantages of the present disclosure will become apparent to one skilled in the art to which the present disclosure relates upon consideration of the following description of the invention with reference to the accompanying drawings, wherein like reference numerals, unless otherwise described refer to like parts throughout the drawings and in which:

FIG. 1 is plan view of a transport trailer transporting power equipment, the transport trailer constructed in accordance with one example embodiment of the present disclosure;

FIG. 2 is a section view of FIG. 1 along section lines A-A; and

FIG. 3 is a perspective view of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures wherein like numbered features shown therein refer to like elements throughout unless otherwise noted. The present disclosure relates generally to a transport trailer with an onboard charging station, and more specifically, to a trailer for transporting powerequipment such as lawn mowers, tractors, and the like, the trailer having a single or plurality of charging stations for providing power requirements to the power equipment.

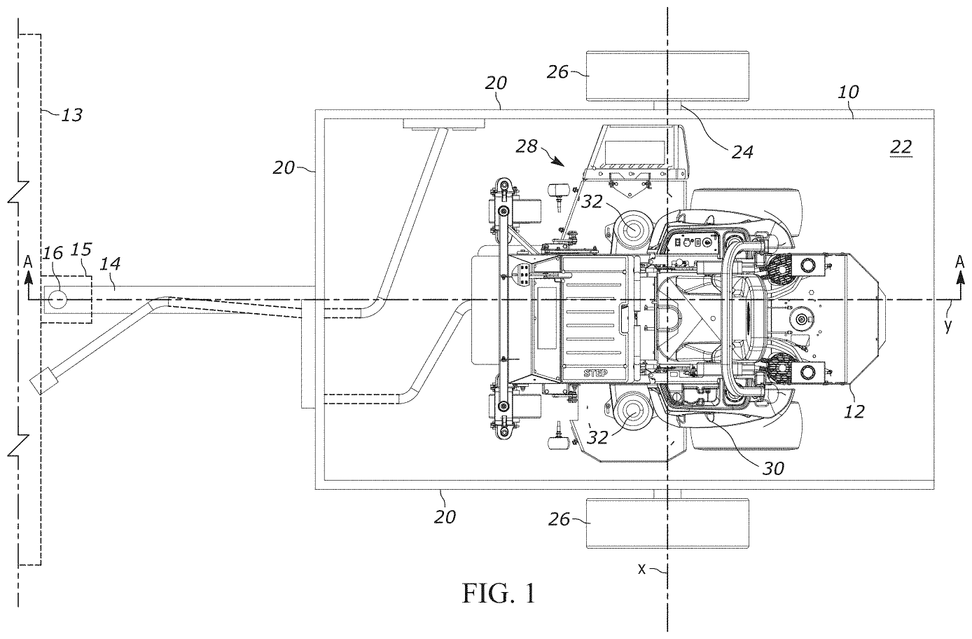

Illustrated in FIG. 1 is a plan view of a power transport trailer 10 constructed in accordance with one example embodiment of the present disclosure. The power transport trailer 10 in the illustrated example embodiment is an open trailer. An open trailer 10 is also referred to as a landscaping trailer used for transporting power equipment 12, such as a lawn mower or lawn tractor. It should be appreciated that other types of transport trailers 10 are contemplated to be within the scope of the present disclosure, including, but not limited to enclosed or semi-enclosed transport trailers constructed with solid walls and/or roof.

The transport trailer 10 is towed by a vehicle, such as an automobile 13 that includes a hitch 15 coupled to the trailer, and a towing bar 14 extending from the trailer. The towing bar 14 includes a receiving hitch 16 for connecting to the hitch or ball 15 of the vehicle 13.

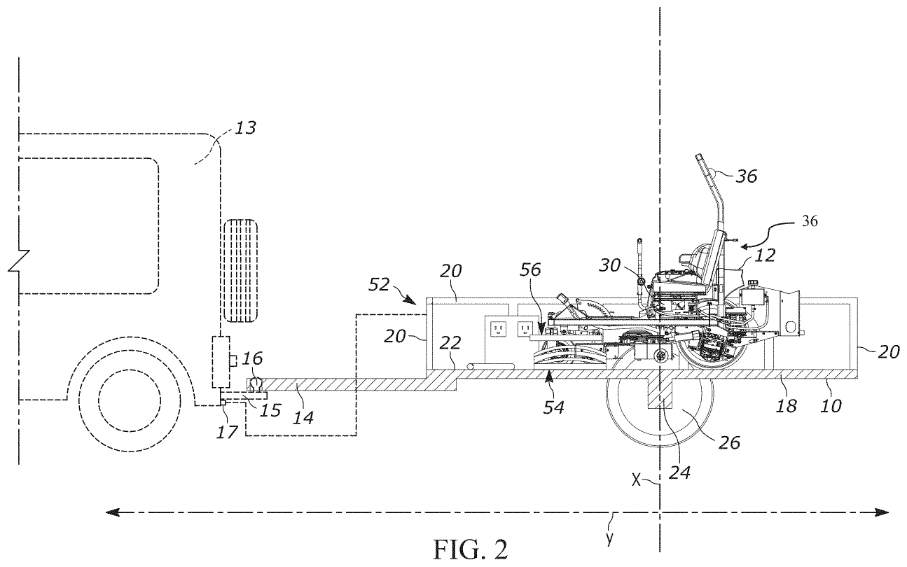

Illustrated in FIG. 2 is a section view of FIG. 1 along section lines A-A. The trailer 10 that can be fabricated from a frame 18 and side rails 20. The frame 18 and/or the side rails 20 including at least one of a metal or non-metallic material. The side rails 20 are for enclosing the power equipment 12 that is disposed on a floor panel 22 attached to the frame 18 and an axle 24 rotatably coupled to a tire and wheel assembly 26. The axle 24 and tire/wheel assembly 26 are positioned about a longitudinal axis Y and lateral axis X (see FIG. 1) to provide proper balance and hitch (or tongue) weight to the vehicle 13 during transport as would be appreciated by one of ordinary skill in the art.

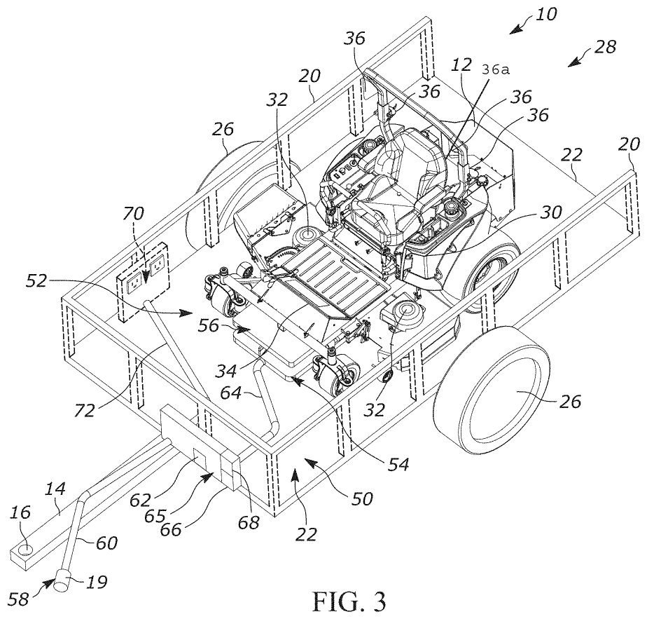

In the illustrated example embodiment, the power equipment 12 is a riding lawn mower having electrical requirements for operating a driving motor 30, such as electric motor or hybrid gas and electric motor. The power equipment 12 in the illustrated example embodiment additionally has electrical requirements for operating ancillary elements 28 (see FIGS. 1 and 3), such as a cutting blade motor or motors 32 (for cutting grass), on-board controllers (such as computers) 34, and/or electrical components 36 (such as an on-board battery pack 36a, other batteries, electro-mechanical devices, head lights, electro-hydraulic lift mechanisms, tail lights, power steering motors, control panels, hour meters, and the like). Further details and requirements of an electric mowers having electrical requirements for operating an electrical driving motor 30 and/or ancillary elements 28 are described U.S. Pat. No. 9,699,965 entitled Articulated Riding Lawn Mower Including Distributed Battery System that issued on Jul. 11, 2017; U.S. Pat. No. 9,210,839 entitled Riding Lawn Mower Including Battey Powered Cutting System that issued on Dec. 15, 2015; U.S. Pat. No. 8,863,485 entitled Hybrid Lawn Mower Drive System that issued on Oct. 21, 2014; and U.S. Pat. No. 7,730,705 entitled Electro-hydraulic Lift Mechanism For Lawn Mower Deck that issued on Jun. 8, 2010 (collectively hereinafter “Patents”). The above-identified patents are incorporated herein by reference in their entireties for all purposes.

It should be appreciated that the power transport trailer can be utilized to transport other types of power equipment 12 having electrical requirements for operating ancillary elements 28 and/or drive motors 30. That is, the power equipment 12 in addition to electrically powered lawn mowers also includes electrically powered all-terrain vehicles (ATVs), walk-behind mowers, snow blowers, snow mobiles, jet skis, and the like.

Illustrated in FIG. 3 is a perspective view of the power transport trailer 10 of FIG. 1, supporting a piece of power equipment 12 in the form of an electric riding lawn mower 12. The power transport trailer 10 comprises an on-board charging station 50. The on-board charging station 50 in one example embodiment includes a power charging arrangement 52 comprising a power transmitter pad 54 and a power capture resonator 56. The power charging arrangement 52 is used to charge the power equipment's 12 driving motor 30 and/or electrical ancillary elements 28.

In one example embodiment, the power charging arrangement 52 receives 12VDC power from a power supply 58 of the towing vehicle 13, from, for example, a battery, alternator, or generator associated with the vehicle. The power supply 58 is transmitted to the arrangement 52 by a trailer hitch plug adapter 17 (coupled to the vehicle's electrical system, see FIG. 2) to receiver 19 tied to electrical conduit 60. In the illustrated example embodiment, the power supplied from the vehicle 13 is 12VDC before being inverted to 120VAC by a power inverter 65 and supplied to the power arrangement 52 through a secondary conduit 64.

In an alternative example embodiment, the power charging arrangement 52 receives power from an external power supply 62 such as line power from 120VAC from a commercial or residential hookup. The line power bypasses the power inverter 65 and is directly supplied to the charging arrangement 52 through the secondary conduit 64. In the illustrated example embodiment, a controller 66 (e.g., a regulator, a processor coupled to and in control of a regulator, etc.) controls the amount and/or duration of the power supplied to the power arrangement 52 from the vehicle 13 or external power supply 62. The controller 66 includes an operator interface 68 (e.g., a touch pad, a touch screen, a smart device, etc.) for altering such parameters. The operator interface 68 is in communication with the controller 66, such that the controller 66 alters an amount and/or duration of the power supplied to the power arrangement 52 based upon an input into the operator interface 68. In another example embodiment, the operator interface 68 includes a control to bypass the power inverter 65 responsive to the power charging arrangement 52 receiving power form the external power supply 62. In yet another example embodiment, the controller 66 instructs the power supply to bypass the power inverter 65 responsive to the power charging arrangement 52 receiving power form the external power supply 62.

While in another example embodiment, the power charging arrangement 52 additionally comprises one or more 120VAC outlets 70 for charging the power equipment's 12 electrical components such as the ancillary elements 28 and/or drive motors 30. The outlets 70 receive their power in one example embodiment from the 12VDC vehicle power supply 58 through conduit 60 before being inverted by power inverter 64 and transmitted to the outlets by a tertiary conduit feed 72.

The power charging arrangement 52 acts as a wireless charging station for the power equipment 12 when the power equipment is positioned on the trailer 10. The power charging arrangement 52 is constructed based on the wireless transfer standard required to charge the electric power equipment 12, e.g. electric riding lawn mowers during transport by the vehicle 13. That is, as the vehicle 13 pulls the trailer 10 with the power equipment 12, power 58 from the vehicle is readily supplied to the power equipment 12 as it travels to the next work or mowing site.

Alternatively, the power arrangement 52 can charge the power equipment 12 when sitting stationary by the 120VAC outlets 70 or on-board batteries of the trailer 10. The 120VAC outlet 70 received power from the power supply 58 and/or an ancillary power supply.

In the illustrated example embodiment of FIG. 3, the transmitter pad 54 is spaced from and below the power capture resonator 56. The power transmitter pad 54 and power capture resonators 56 are sized and designed to have the power equipment 12 mounted upon them. That is, the power transmitter source pad 54 and resonators 56 are sized and configured based upon the dimensions of the power equipment 12. Further, the power transmitter source pad 54 and resonators 56 are configured to provide the appropriate power levels for individual applications performed by the power equipment 12, which may be more than 3 kW for a compact tractor charging system or may be less for a walk behind push mower. The resonator 56 is configured to receive energy from a source resonator or the transmitter pad 54 and may be used to recharge batteries, power electronics or devices, and the like of the power equipment 12. One or more of the resonators 56 may be mounted on the underside of the power equipment 12, in the front of the power equipment, towards the back of the power equipment, and the like. Further discussion about the construction, sizing, and applications of resonators 56 and transmitter pads 54 can be found in U.S. published patent application number U.S. 2017/0053737 that published on Feb. 23, 2017 and is entitled INTEGRATED RESONATOR-SHIELD STRUCTURES. U.S. published patent application number U.S. 2017/0053737 is incorporated herein by reference in its entirety for all purposes.

In alternative example embodiments, the resonator 56 is mounted inside the power equipment 12. That is, the resonator 56 can be mounted in floor panels, the wheel wells, the spare tire well, or other parts of the power equipment 12 that may be constructed of non-metallic material, such as plastic, carbon fiber, composites, and the like, providing a window for the magnetic fields to pass through to the resonator.

In an alternative example embodiment, the resonator 56 may include connections to the power equipment 12 for charging batteries, capacitors, to coolant sources to provide active cooling or heating to the electronics and components. In another example embodiment, the power transmitter pad 54 is mounted or loosely positioned on the floor panel 22 and integrated into a rubber mat or a platform. The rubber mat integrated with the transmitter pad 54 is connected to the vehicle's power source 58, allowing wireless power transfer to the power equipment 12 when the vehicle 13 is idling or driving/towing the power equipment and the power equipment is positioned over the pad or rubber mat and the power capture resonator 56 is in alignment with power transmitter mat 54 as depicted in FIG. 3.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. In one non-limiting embodiment the terms are defined to be within for example 10%, in another possible embodiment within 5%, in another possible embodiment within 1%, and in another possible embodiment within 0.5%. The term “coupled” as used herein is defined as connected or in contact either temporarily or permanently, although not necessarily directly and not necessarily mechanically. A device or structure that is “configured” in a certain way is configured in at least that way, but may also be configured in ways that are not listed.

To the extent that the materials for any of the foregoing embodiments or components thereof are not specified, it is to be appreciated that suitable materials would be known by one of ordinary skill in the art for the intended purposes.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A transport trailer for supplying electrical power to power equipment during transport, the transport trailer comprising:
a power coupling for receiving power from a vehicle towing the transport trailer; and
a conduit for transmitting the power from the power coupling to a wireless power charging arrangement, the wireless power charging arrangement comprising a power transmitting pad compatible with a power capture resonator used to charge an on-board battery of power equipment.

2. The transport trailer of claim 1 wherein the power capture resonator supplies power to power equipment during the transport of the equipment while residing on the transport trailer.

3. The transport trailer of claim 1 wherein said conduit further comprises a first conduit and a second conduit, the first and second conduits coupled to an inverter for converting the power supplied from a vehicle during transporting of the trailer from a first power standard to a second power standard.

4. The transport trailer of claim 3 wherein said first power standard is 12VDC and said second power standard is 120VAC.

5. The transport trailer of claim 3, wherein the power charging arrangement comprises on or more outlets, wherein the invertor provides power to the outlets via a third conduit.

6. The transport trailer of claim 2 wherein the power capture resonator supplies power to the power equipment during the transport of the power equipment while residing on the transport trailer.

7. The transport trailer of claim 1 wherein a controller controls an amount and a duration of power transmitted to the power equipment by the wireless power charging arrangement.

8. The transport trailer of claim 6 wherein the controller is coupled to an operator interface, wherein a user inputs one or more parameters based upon the power equipment being transported, the at least one parameter altering at least one of the power amount of power duration to the wireless power charging arrangement.

9. The transport trailer of claim 1, wherein the power equipment comprises an electrically powered lawn mower.

10. The transport trailer of claim I, comprising a floor panel, wherein the power transmitting pad is mounted on the floor panel.

11. The transport trailer of claim 1, comprising a floor panel, wherein the power transmitting pad is integrated into a rubber mat comprised on the floor panel.

12. The transport trailer of claim 1, wherein the power transmitting pad is vertically spaced from the power capture resonator, wherein the power equipment is mounted upon the power capture resonator.

13. The transport trailer of claim 1, wherein the power equipment is mounted upon and charged by the wireless power charging arrangement during the transport of the power equipment while residing on the transport trailer.

14. A method of supplying electrical power to power equipment positioned on a trailer during transport, the method comprising the steps of:
providing a power coupling for receiving power from a vehicle towing a transport trailer;
configuring dimensions of a wireless power charging arrangement comprising a power transmitting pad and a power capture resonator, the power transmitting pad compatible with the power capture resonator, to comport to an indicated specifications of an item of power equipment; and
positioning the wireless power charging arrangement on a floor panel of the transport trailer, the wireless power charging arrangement in electrical communication with the power coupling.

15. The method of claim 14 comprising configuring the power capture resonator to charge an on-board battery of the power equipment during the transport of the power equipment while situated on the transport trailer.

16. The method of claim 14 comprising providing a conduit for transmitting power from the vehicle to the wireless power charging arrangement, the conduit further comprising a first conduit and a second conduit, the first and second conduits couplable to an inverter for converting the power supplied from a vehicle during transporting of the trailer from a first power standard to a second power standard.

17. The method of claim 14 comprising providing a controller in electrical communication with the power supply and the wireless power charging arrangement, the controller configured to control an amount and duration of power transmitted to the power equipment by the wireless power charging arrangement.

18. The method of claim 17 further providing an operator interface in electrical communication with the controller, wherein a user inputs the amount of power to be provided to the power equipment based upon the power equipment being transported.

19. The method of claim 14 the providing the wireless power charging arrangement on a floor panel comprising vertically spacing the power transmitting pad from the power capture resonator, wherein the power equipment is adjacent to the power capture resonator during transport.

20. A transport trailer for supplying electrical power to power equipment during transport, the transport trailer comprising:
a floor panel coupled to a set of wheels by an axle;
a hitch coupled to the floor panel, the hitch for coupling the transport trailer to a vehicle;
a power coupling for receiving power from the vehicle towing the transport trailer;
conduit for transmitting the power from the power coupling to a wireless power charging arrangement, the wireless power charging arrangement comprising:
a power transmitting pad, wherein the power transmitting pad is integrated into a rubber mat disposed on the floor panel; and
a power capture resonator compatible with the power transmitting pad, the power capture resonator vertically spaced from the power transmitting pad, wherein the power equipment is mounted upon the power capture resonator to charge an on-board battery of the power equipment during the transport of the power equipment while residing on the transport trailer.
